(19) United States
(12) Patent Application Publication
(10) Pub. No.: US 2026/0253876 A1
(43) Pub. Date: Aug. 27, 2026

(54) NEGATIVE ELECTRODE ACTIVE MATERIAL COMPRISING MAGNESIUM SILICATE FOR LITHIUM SECONDARY BATTERY, METHOD FOR PREPARING SAME, AND LITHIUM SECONDARY BATTERY COMPRISING SAME

(71) Applicants: Hyundai Motor Company, Seoul (KR); Kia Corporation, Seoul (KR); IUCF-HYU (Industry-University Cooperation Foundation Hanyang University, Seoul (KR)

(72) Inventors: Sanghun Lee, Hwaseong (KR); Seung Tae Kim, Hwaseong (KR); Kikang Lee, Hwaseong (KR); Kimin Kwon, Hwaseong (KR); Seung-Min Oh, Hwaseong (KR); Seongjung Heo, Hwaseong (KR); Ji Young Kim, Seongnam (KR); Hyunsik Yoon, Seoul (KR); Hansu Kim, Seoul (KR)

(21) Appl. No.: 19/235,138

(22) Filed: Jun. 11, 2025

(30) Foreign Application Priority Data
Feb. 21, 2025 (KR) 10-2025-0022851

(51) Int. Cl. H01M 4/36; H01M 4/38; H01M 4/58; H01M 10/0525

(52) U.S. Cl. CPC H01M 4/364; H01M 4/386; H01M 4/5825; H01M 10/0525

(57) ABSTRACT

Provided is a negative electrode active material for a lithium secondary battery including magnesium silicate and crystalline silicon, optionally with magnesium oxide in specified weight ratios. It is formed by mixing silicon, silicon monoxide, and magnesium hydride, then heat-treating to produce a stable magnesium silicate phase while retaining crystalline silicon. This enhances initial efficiency, reduces irreversible capacity loss, and improves charge-discharge cycle life. The method can further include pulverizing and optionally carbon-coating the heat-treated product to adjust pore structure and electrical conductivity. The resulting electrode material provides high energy density and good conductivity, enabling better performance in lithium-ion cells.

### CROSS-REFERENCE TO RELATED APPLICATION

This present application claims under 35 U.S.C. § 119(a) the benefit of Korean Patent Application No. 10-2025-0022851, filed on Feb. 21, 2025, in the Korean Intellectual Property Office, the entire disclosure of which is incorporated herein by reference.

### BACKGROUND

### Technical Field

The present disclosure relates to a negative electrode active material comprising a magnesium silicate for a lithium secondary battery, a method for preparing same, and a lithium secondary battery comprising same.

### Background

Lithium secondary batteries are widely used in various applications, ranging from small electronic devices such as smartphones to medium and large energy storage devices, including batteries for electric vehicles. Recently, there has been an increasing demand for high energy density batteries as a countermeasure to global regulations targeting CO₂ and greenhouse gas emissions.

Graphite, which is commonly used as a negative electrode for lithium secondary batteries, has a low theoretical capacity of 372 mAh/g, resulting in limited energy density. To overcome this limitation, various materials are under investigation. Of these materials, silicon has a discharge capacity of 3579 mAh/g, which is about 10 times higher than graphite, making it a promising next-generation negative electrode active material. However, silicon suffers from poor cycle life characteristics due to particle fragmentation and electrode delamination resulting from high expansion (approximately 300%) during charging. In addition, silicon oxide SiOx (0<x<2) has a discharge capacity more than three times that of graphite, while showing superior cycle life characteristics compared to silicon, but has low initial efficiency due to irreversible reactions occurring during the initial charging process of silicon oxide.

To address these issues, efforts have been made to adjust the oxygen or silicon content in the silicon oxide materials. However, such modifications often lead to reduced cycle life. In addition, there have been studies on using composites formed by reacting silicon oxide with other metal materials such as Li (prelithiation), Mg, and Ca as negative electrode materials for lithium secondary batteries, but these resulted in decreased discharge capacity.

Therefore, there is a need to develop materials that can simultaneously address the various issues of silicon negative electrode active materials to implement high energy density lithium storage materials.

### SUMMARY

Some embodiments of the present disclosure are directed to providing a negative electrode active material for a lithium secondary battery that exhibits high efficiency, high capacity, and long cycle life characteristics, a method for preparing same, and a lithium secondary battery comprising same.

Some embodiments of the present disclosure are directed to providing a negative electrode active material that can be applied to green technology fields using batteries, such as electric vehicles.

Some embodiments of the present disclosure may provide a negative electrode active material for a lithium secondary battery, the negative electrode active material including a magnesium silicate including one or more selected from the group consisting of Mg₂SiO₄ and MgSiO₃, and crystalline silicon.

The negative electrode active material for a lithium secondary battery according to one embodiment may further include magnesium oxide (MgO).

The negative electrode active material for a lithium secondary battery according to one embodiment may include 1 to 150 parts by weight of the magnesium silicate based on 100 parts by weight of the crystalline silicon.

The negative electrode active material for a lithium secondary battery according to one embodiment may include the magnesium silicate and the crystalline silicon at a weight ratio of 1:0.5 to 1:1.5.

The negative electrode active material for a lithium secondary battery according to one embodiment may include 0.5 to 5 parts by weight of the magnesium oxide based on 100 parts by weight of the crystalline silicon.

The crystalline silicon according to one embodiment may be polycrystalline silicon, and the polycrystalline silicon may include a first crystalline silicon including a (111) plane, a second crystalline silicon including a (220) plane, and a third crystalline silicon including a (311) plane.

A ratio of grain sizes of the first crystalline silicon, the second crystalline silicon, and the third crystalline silicon according to one embodiment may be 1:(0.5 to 1):(0.5 to 1).

Some embodiments of the present disclosure may provide a method for preparing a negative electrode active material for a lithium secondary, the method including preparing a mixed powder by mixing silicon (Si), silicon monoxide (SiO), and magnesium hydride (MgH₂), and obtaining a heat-treated product by heat-treating the mixed powder.

The mixed powder according to one embodiment may include the silicon, the silicon monoxide (SiO), and the magnesium hydride at a weight ratio of 1:(1 to 2):(0.1 to 1).

The heat treatment according to one embodiment may be performed at 700° C. to 1000° C.

The method for preparing a negative electrode active material for a lithium secondary battery according to one embodiment may further include pulverizing the heat-treated product, and carbon coating the heat-treated product pulverized in the pulverizing.

The pulverizing according to one embodiment may be performed by a ball mill method.

The ball mill method according to one embodiment may be performed with a ball-to-powder weight ratio (BPR) of 5:1 to 50:1 for 10 to 36 hours.

The carbon coating according to one embodiment may be performed under an argon (Ar) gas atmosphere at 350° C. to 1200° C. for 0.5 to 10 hours.

Some embodiments of the present disclosure may provide a negative electrode for a lithium secondary battery, the negative electrode including the negative electrode active material for a lithium secondary battery.

Some embodiments of the present disclosure may provide a lithium secondary battery including the negative electrode for a lithium secondary battery, a positive electrode, a separator positioned between the negative electrode and the positive electrode, and an electrolyte.

In some embodiments, a negative electrode active material for a lithium secondary battery, wherein the negative electrode active material is obtained by: preparing a mixture of silicon, silicon monoxide, and magnesium hydride; heat-treating the mixture at a temperature of about 700° C. to 1000° C. to form a magnesium silicate phase comprising Mg2SiO4 and/or MgSiO3; and optionally pulverizing and carbon-coating the heat-treated product, wherein the negative electrode active material comprises: the magnesium silicate phase, and crystalline silicon.

About 1 to 150 parts by weight of the magnesium silicate phase may be present based on 100 parts by weight of the crystalline silicon.

The negative electrode active material may further include magnesium oxide in an amount of about 0.5 to 5 part by weight, based on 100 parts by weight of the crystalline silicon.

The crystalline silicon may be polycrystalline silicon comprising a first crystalline silicon including a (111) plane, a second crystalline silicon including a (220) plane, and a third crystalline silicon including a (311) plane.

A a ratio of average grain sizes of the first crystalline silicon, the second crystalline silicon, and the third crystalline silicon may be 1:(0.5 to 1):(0.5 to 1).

The negative electrode active material for a lithium secondary battery according to the present disclosure may improve capacity by including a high content of silicon.

The lithium secondary battery including the negative electrode active material for a lithium secondary battery according to the present disclosure may exhibit improved cycle life characteristics.

The lithium secondary battery including the negative electrode active material for a lithium secondary battery according to the present disclosure may improve the initial efficiency of the negative electrode through irreversible phase formation reactions.

As discussed, the method and system suitably include use of a controller or processer.

In another embodiment, vehicles are provided that comprise an apparatus as disclosed herein.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a flowchart showing the preparation process of a negative electrode active material for a lithium secondary battery according to some embodiments of the present disclosure.

FIG. 2 is an X-ray diffraction (XRD) analysis result of a negative electrode active material for a lithium secondary battery according to examples of the present disclosure.

FIG. 3 is Raman spectroscopic measurement result of a negative electrode active material according to examples of the present disclosure and comparative examples.

FIG. 4A shows the initial efficiency, and FIG. 4B the cycle life characteristics, of cells comprising negative electrode active materials according to Examples 1 to 3 of the present disclosure and Comparative Example 1.

FIG. 5A shows the initial efficiency, and FIG. 5B the cycle life characteristics, of cells comprising negative electrode active materials according to Example 1 of the present disclosure and Comparative Examples 1 to 3.

FIG. 6A shows the initial efficiency, and FIG. 6B the cycle life characteristics, of cells comprising negative electrode active materials according to Example 1, Comparative Example 1, and Comparative Example 4 of the present disclosure.

### DETAILED DESCRIPTION

Hereinafter, the present disclosure will be described in more detail. However, the following embodiments and implementation examples are provided merely as references for describing the present disclosure in detail, and the present disclosure is not limited thereto and may be implemented in various forms.

Unless otherwise defined, all technical and scientific terms used herein have the same meaning as commonly understood by those skilled in the art to which the present disclosure pertains.

The terms used herein are intended merely to describe particular embodiments effectively and are not intended to limit the present disclosure. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

The term “magnesium silicate” refers to a compound including one or more magnesium-silicon-oxygen phases.

The term “crystalline silicon” refers to silicon having a crystal structure discernible by techniques such as X-ray diffraction, Raman spectroscopy, or electron diffraction.

The term “polycrystalline silicon” refers to silicon composed of multiple crystalline grains or domains, each of which exhibits an ordered lattice but may differ in orientation.

The following provides a more detailed description of the present disclosure.

The present disclosure provides a negative electrode active material for a lithium secondary battery, the negative electrode active material including a magnesium silicate including one or more selected from the group consisting of Mg₂SiO₄ and MgSiO₃, and crystalline silicon. The negative electrode active material for a lithium secondary battery comprises an irreversible phase of the magnesium silicate that does not react with lithium ions and crystalline silicon, thereby providing improved capacity and initial efficiency, and improving cycle life characteristics.

In one embodiment, the negative electrode active material for a lithium secondary battery may further comprise magnesium oxide (MgO). By satisfying this, the initial efficiency and cycle life characteristics of the lithium secondary battery may be further improved.

In the present specification, crystalline silicon may mean silicon that exists in a three-dimensional structure at the atomic dimension level.

When the negative electrode active material for a lithium secondary battery of the present disclosure comprises the crystalline silicon, the high theoretical capacity of the crystalline silicon may enable the implementation of high energy density batteries. In addition, the crystalline silicon has excellent electrical conductivity, enabling fast charging and discharging of the battery.

In one embodiment, the negative electrode active material for a lithium secondary battery may comprise 1 to 150 parts by weight, 4.5 to 125 parts by weight, specifically 50 to 100 parts by weight, more specifically 80 to 90 parts by weight of the magnesium silicate based on 100 parts by weight of the crystalline silicon. By satisfying this, the capacity, initial efficiency, and cycle life characteristics of the lithium secondary battery may be improved.

In one embodiment, the negative electrode active material for a lithium secondary battery may comprise 0.5 to 5 parts by weight, specifically 1 to 3 parts by weight, more specifically 1.2 to 2 parts by weight of the magnesium oxide based on 100 parts by weight of the crystalline silicon. By satisfying this, the initial efficiency and cycle life characteristics of the lithium secondary battery may be further improved.

In one embodiment of the present disclosure, the crystalline silicon may be polycrystalline silicon, and the polycrystalline silicon may comprise a first crystalline silicon including a (111) plane, a second crystalline silicon including a (220) plane, and a third crystalline silicon including a (311) plane. By satisfying this, high energy density batteries may be implemented, and the charging and discharging rate of the battery may be improved.

In one embodiment, the ratio of grain sizes of the first crystalline silicon, the second crystalline silicon, and the third crystalline silicon may be 1:(0.5 to 1):(0.5 to 1), specifically 1:(0.6 to 0.9):(0.6 to 0.9), more specifically 1:(0.7 to 0.8):(0.8 to 0.85), but is not limited thereto as long as the objectives of the present disclosure can be achieved.

The present disclosure further provides a method for preparing a negative electrode active material for a lithium secondary battery, the method comprising preparing a mixed powder by mixing silicon (Si), silicon monoxide (SiO), and magnesium hydride (MgH₂), and obtaining a heat-treated product by heat-treating the mixed powder.

In one embodiment, the mixed powder may comprise the silicon, the silicon monoxide (SiO), and the magnesium hydride at a weight ratio of 1:(1-2):(0.1-1), specifically 1:(1.3-1.7):(0.2-0.5). A battery comprising the negative electrode active materials prepared by satisfying this range may exhibit improved capacity, initial efficiency, and cycle life characteristics.

In one embodiment, the heat treatment may be performed at 700° C. to 1000° C., specifically 750° C. to 900° C. By satisfying this range, the formation of the magnesium silicate and crystalline silicon is facilitated.

In one embodiment, the method for preparing a negative electrode active material for a lithium secondary battery may further comprise pulverizing the heat-treated product, and carbon coating the heat-treated product pulverized in the pulverizing. By further comprising the pulverizing, internal pores can be formed larger, improving the cycle life characteristics of the battery. In addition, by further comprising the carbon coating, the cycle life characteristics, electrochemical properties, and thermal stability of the battery may be improved.

In one embodiment, the pulverizing may be performed by a ball mill, high-energy ball mill, attrition mill, jet mill, or resonance acoustic mixer method, and specifically by a high-energy ball mill method, but is not limited thereto as long as the objectives of the present disclosure can be achieved.

In one embodiment, the ball mill method may have a ball-to-powder weight ratio (BPR, big ball:small ball) of 1:1 to 10:1, specifically 2:1 to 5:1. The ball mill method may be performed for 10 to 36 hours, specifically 15 to 25 hours. In addition, the ball mill method may be performed at a rotation speed of 50 rpm to 2000 rpm, specifically 100 rpm to 1000 rpm, but is not limited thereto.

In one embodiment, the carbon coating may be performed under an argon (Ar) gas atmosphere at 350° C. to 1200° C., specifically 600° C. to 1000° C., for 0.5 to 10 hours, specifically 1 to 5 hours, but is not limited thereto.

In addition, the present disclosure provides a negative electrode for a lithium secondary battery comprising the negative electrode active material for a lithium secondary battery.

The description of the negative electrode active material for a lithium secondary battery is as described above and is therefore omitted.

In one embodiment, the negative electrode for a lithium secondary battery may further comprise a binder, and the binder may be used without limitation as long as it is used in the art for manufacturing negative electrodes for lithium secondary batteries.

In addition, the present disclosure provides a lithium secondary battery comprising the negative electrode for a lithium secondary battery, a positive electrode, a separator positioned between the negative electrode and the positive electrode, and an electrolyte.

The positive electrode, separator, and electrolyte are not particularly limited, and the present disclosure may adopt those known in the art. Specific examples are as follows.

In one embodiment, the positive electrode may be manufactured by preparing a mixture by mixing and stirring a negative electrode active material with a solvent, and if necessary, a binder, a conductive material, and a dispersant, and then coating the mixture onto a metal current collector, drying the mixture, and pressing the mixture.

In one embodiment, the positive electrode active material may be any active material commonly used for the positive electrode of a lithium secondary battery. For example, the positive electrode material may include lithium metal oxide particles comprising one or more metals selected from the group consisting of Ni, Co, Mn, Na, Mg, Ca, Ti, V, Cr, Cu, Zn, Ge, Sr, Ag, Ba, Zr, Nb, Mo, Al, Ga, B, and combinations thereof.

In one embodiment, a common conductive carbon material may be used as the conductive material, without any particular limitation.

In one embodiment, the metal current collector may be any metal with high conductivity that allows the mixture of the positive electrode active material mixture to adhere easily and is non-reactive within the voltage range of the battery. As non-limiting examples, the positive electrode current collector may be selected from aluminum, nickel, or foils made by combinations thereof.

In one embodiment, the separator may be a separator having micropores through which ions can pass, and as non-limiting examples, may be a combination of one or more selected from the group consisting of glass fiber, polyester, polyethylene, polypropylene, and polytetrafluoroethylene, and may be in the form of a non-woven fabric or woven fabric. Specifically, the lithium secondary battery may primarily use polyolefin-based polymer separators such as polyethylene and polypropylene, but the present disclosure is not limited thereto. In addition, to enhance heat resistance or mechanical strength, a separator coated with a composition comprising ceramic components or polymer materials may also be used, the separator may optionally have a single-layer or multi-layer structure, and a separator known in the art may be used, but the present disclosure is not limited thereto.

In one embodiment, the electrolyte may include organic liquid electrolytes, inorganic liquid electrolytes, solid polymer electrolytes, gel polymer electrolytes, solid inorganic electrolytes, molten inorganic electrolytes, and the like that can be used in manufacturing lithium secondary batteries but are not limited thereto.

In one embodiment, the electrolyte may comprise a non-aqueous organic solvent and a metal salt.

In one embodiment, the non-aqueous organic solvent may include, for example, non-protic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethyl sulfoxide, 1,3-dioxolane, formamide, dimethylformamide, dioxolane, acetonitrile, nitromethane, methyl formate, methyl acetate, phosphoric triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl pyropionate, and ethyl propionate.

In one embodiment, among the carbonate-based organic solvents, cyclic carbonates such as ethylene carbonate and propylene carbonate may be preferably used as high-viscosity organic solvents with high dielectric constants that well dissociate lithium salts, and when these cyclic carbonates are mixed in appropriate ratios with low-viscosity, low-dielectric constant linear carbonates such as dimethyl carbonate and diethyl carbonate, electrolytes with high electrical conductivity can be created, making them more preferably used.

In one embodiment, lithium salts may be used as the metal salt, and the lithium salt may be a material that dissolves well in the non-aqueous electrolyte, for example, the anion of the lithium salt may include one or more selected from the group consisting of F—, Cl—, I—, NO₃—, N(CN)₂—, BF₄—, ClO₄—, PF₆—, (CF₃)₂PF₄—, (CF₃)₃PF₃—, (CF₃)₄PF₂—, (CF₃)₅PF—, (CF₃)₆P—, CF₃SO₃—, CF₃CF₂SO₃—, (CF₃SO₂)₂N—, (FSO₂)₂N—, CF₃CF₂ (CF₃)₂CO—, (CF₃SO₂)₂CH—, (SF₅)₃C—, (CF₃SO₂)₃C—, CF₃(CF₂)₇SO₃—, CF₃CO₂—, CH₃CO₂—, SCN—, and (CF₃CF₂SO₂)₂N—.

In one embodiment, the electrolyte may further include one or more additives such as difluoro ethylene carbonate or other haloalkylene carbonate compounds, pyridine, triethyl phosphite, triethanolamine, cyclic ethers, ethylene diamine, n-glyme, hexaphosphoric triamide, nitrobenzene derivatives, sulfur, quinone imine dyes, N-substituted oxazolidinones, N,N-substituted imidazolidines, ethylene glycol dialkyl ethers, ammonium salts, pyrrole, 2-methoxy ethanol, or aluminum trichloride for improving the cycle life characteristics of the battery, preventing battery capacity reduction, or improving the discharge capacity of the battery.

In one embodiment, the external shape of the lithium secondary battery is not particularly limited, but may be selected from, for example a cylindrical shape using a can, a square shape, a pouch shape, or a coin shape.

Hereinafter, various examples of the present disclosure and comparative examples will be described. However, the following examples are merely various examples of the present disclosure, and the present disclosure is not intended to be limited thereto.

### Example 1

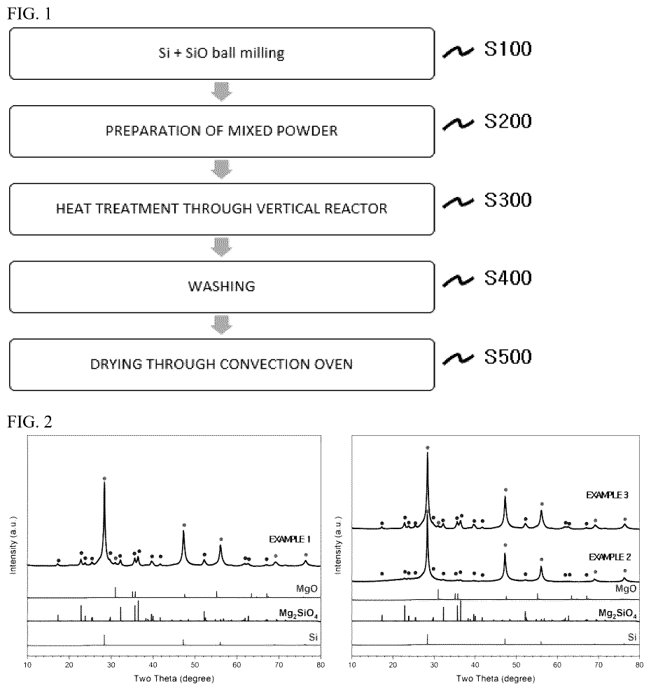

Example 1 was carried out in the same order as shown in FIG. 1 below. A mixed powder was prepared by pulverizing 2.238 g of Si powder and 3.512 g of SiO powder by a high-energy ball milling method under a BPR 2:1 condition for 18 hours (S100) and then mixing with 0.911 g of MgH₂ powder and 5 g of NaCl powder (S200). The mixed powder was transferred to an alumina crucible, additionally coated with 3 g of NaCl powder on top, and heat-treated using a vertical furnace under an Ar atmosphere at 800° C. for 5 hours with a heating rate of 5° C./min to obtain a heat-treated product (S300). A powder was obtained by pulverizing the heat-treated product in a mortar. To remove residual salt from the prepared powder, 50 ml of acetic acid aqueous solution per 1 g was used to stir for 30 minutes, then filtered with a filter (S400), and dried in a convection oven for a day to prepare a negative electrode active material (S500).

### Example 2

A negative electrode active material was prepared in the same manner as in Example 1, except that the heat treatment temperature was 700° C.

### Example 3

A negative electrode active material was prepared in the same manner as in Example 1, except that the heat treatment temperature was 750° C.

### Comparative Example 1

2.238 g of Si powder and 3.512 g of SiO powder were pulverized by a high-energy ball milling method under a BPR 20:1 (big ball:small ball=2:1) condition for 18 hours and used as a negative electrode active material.

### Comparative Example 2

SiO powder was used as a negative electrode active material without any separate treatment.

### Comparative Example 3

A negative electrode active material was prepared in the same manner as in Example 1, except that 5.75 g of SiO powder alone was used as the base material, and 1.71 g of MgH₂ powder was used.

### Comparative Example 4

A negative electrode active material was prepared in the same manner as in Example 1, except that 0.95 g of Mg powder was used instead of 0.911 g of MgH₂ powder.

### Experimental Example 1: X-Ray Diffraction Analysis

The negative electrode active materials prepared according to the examples and comparative examples were analyzed by X-ray diffraction and shown in FIG. 2.

The specific X-ray diffraction analysis conditions were as follows:
i) Equipment: Bruker, D8 advance
ii) Conditions: Cu Kα radiation (1.5418 Å)

FIG. 2 shows the X-ray diffraction (XRD) analysis results of negative electrode active materials according to Examples 1 to 3 of the present disclosure.

Through FIG. 2, Mg₂SiO₄ phase, Si phase, and a small amount of MgO phase were confirmed in Examples 1 and 3. For Example 2, Si phase and a small amount of Mg₂SiO₄ phase were confirmed, and no MgO-related peaks were observed. Through this, it was confirmed that different products were formed as the heat treatment temperature increased.

### Experimental Example 2: Quantitative Analysis

To quantify the ratios of Si, Mg₂SiO₄, and MgO in Examples 1 to 3, Rietveld analysis was performed on the X-ray diffraction analysis results, and the results are listed in Table 1.

TABLE 1

| | Si | Mg₂SiO₄ | MgO |
|---|---|---|---|
| | (%) | (%) | (%) |
| Example 1 | 53.7 | 45.6 | 0.8 |
| Example 2 | 95.4 | 4.6 | — |
| Example 3 | 54.0 | 45.3 | 0.7 |

As can be seen from Table 1, the proportion of Mg₂SiO₄ increased in Examples 1 and 3 compared to Example 2.

### Experimental Example 3: Grain Size Measurement

The grain sizes of each component included in the negative electrode active materials of Examples 1 to 3 were calculated using the following Scherrer equation, and the results are shown in Table 2:

$$Scherrer equation$$

$$D = \frac{K \cdot λ}{β \cdot cos θ}$$

K (Scherrer constant)=0.94
λ (wavelength of the X-ray)=1.5406 Å
β=Full Width at Half Maximum (FWHM)
θ=Bragg angle

TABLE 2

| | Example 1 | Example 2 | Example 3 |
|---|---|---|---|
| c-Si | 20.31 | 37.17 | 37.17 |
| (111) | | | |
| c-Si | 15.11 | 25.08 | 25.09 |
| (220) | | | |
| c-Si | 16.39 | 23.35 | 23.35 |
| (311) | | | |
| c-Mg₂SiO₄ | 20.96 | 32.76 | 32.68 |
| (220) | | | |
| c-Mg₂SiO₄ | 20.61 | 24.37 | 24.37 |
| (311) | | | |
| c-Mg₂SiO₄ | 21.56 | 25.80 | 25.8 |
| (121) | | | |

As can be seen from Table 2, it was confirmed that the sizes of c-Si and c-Mg2SiO4 in Example 1 were smaller compared to Examples 2 and 3.

### Experimental Example 4: Raman Spectroscopy

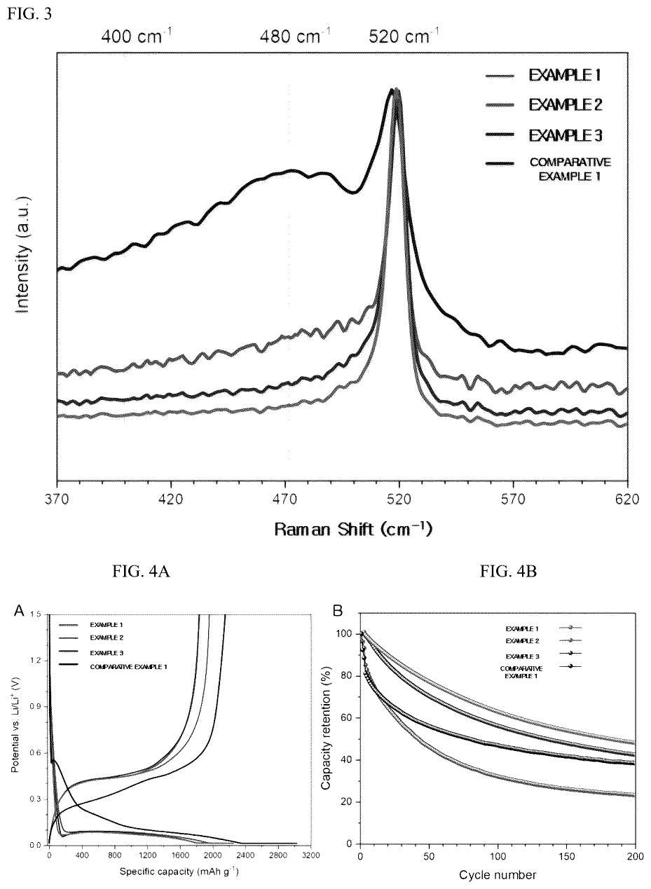

To confirm the degree of reaction progress according to the heat treatment temperature, Raman spectroscopy was performed on Examples 1 to 3 and Comparative Example 1, and the results are shown in FIG. 3.

As can be seen from FIG. 3, 400 cm⁻¹ and 480 cm⁻¹ bands corresponding to a-SiO₂ and a-Si, respectively, were confirmed in Comparative Example 1. In contrast, in Examples 1 to 3, the bands corresponding to a-SiO₂ and a-Si decreased, and a 520 cm⁻¹ band corresponding to c-Si appeared. Accordingly, it was confirmed that the degree of reaction progress differed as the heat treatment temperature increased.

### Experimental Example 5: Evaluation of Initial Efficiency and Cycle Life Characteristics

Electrochemical evaluations were conducted on the negative electrode active materials prepared according to the examples and comparative examples.

Specifically, a slurry composition was prepared by mixing the prepared negative electrode active material, Super-C as a conductive material, and PAA as a binder in a mass ratio of 8:1:1 with DI water. The composition was coated on copper foil, then vacuum dried at 120° C. for 6 hours to prepare a negative electrode.

A CR2032 coin cell was assembled by using lithium metal as a counter electrode, placing a polyethylene separator between the negative electrode and the counter electrode, and injecting an electrolyte of 1M LiPF₆ in EC:EMC:DEM (2:2:5) with 10 wt % FEC additive. The assembled coin cell was allowed to rest at room temperature for 12 hours before charging and discharging.

The prepared half-cell underwent 3 formation cycles at room temperature (25° C.). It was charged at a constant current of 0.1C until the voltage reached 0.01V (vs. Li+/Li), followed by constant-voltage charging while maintaining 0.01V (vs. Li+/Li) until the current reached 0.01C cut-off. It was discharged at a constant current of 0.1C until the voltage reached 1.5V (vs. Li+/Li).

Subsequently, it was charged at a constant current of 0.5C until the voltage reached 0.01V (vs. Li+/Li), followed by constant-voltage charging while maintaining 0.01V (vs. Li+/Li) until the current reached 0.01C cut-off. It was discharged at a constant current of 0.5C until the voltage reached 1.5V (vs. Li+/Li). The results are shown in FIGS. 4A and 4B and Table 3.

TABLE 3

| | Charge | Discharge | Initial |
|---|---|---|---|
| | capacity | capacity | efficiency |
| | (mAh g⁻¹) | (mAh g⁻¹) | (%) |
| Example 1 | 2254 | 1961 | 87.0 |
| Example 2 | 2230 | 1842 | 82.5 |
| Example 3 | 2126 | 1836 | 86.3 |
| Comparative | 3032 | 2156 | 71.1 |
| Example 1 | | | |

As can be seen from FIG. 4A and Table 3, Examples 1 to 3 showed significantly improved initial efficiency compared to Comparative Example 1, and as can be seen from FIG. 4B, Examples 1 and 3 showed improved cycle life characteristics compared to Comparative Example 1.

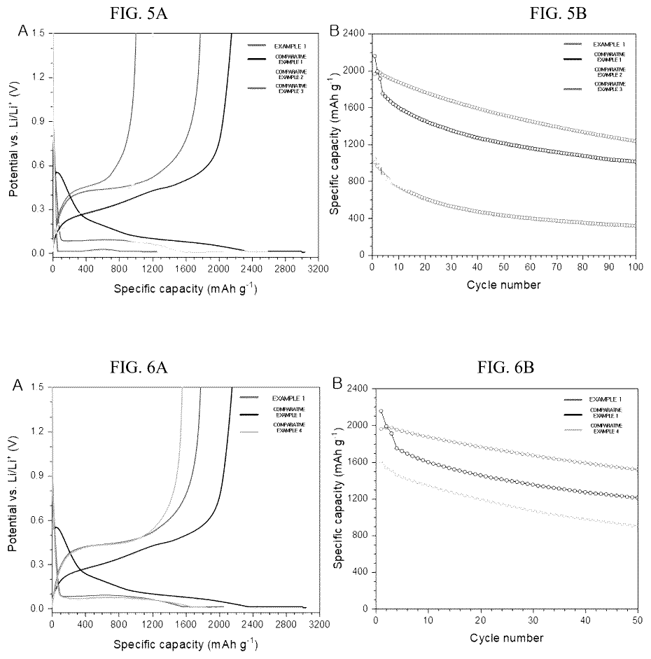

As Example 1 performed best in terms of initial efficiency and cycle life characteristics, Example 1 was compared with the remaining comparative examples using the same experimental method, and the results are shown in FIGS. 5A and 5B and FIGS. 6A and 6B, and Table 4.

TABLE 4

| | Charge | Discharge | Initial |
|---|---|---|---|
| | capacity | capacity | efficiency |
| | (mAh g⁻¹) | (mAh g⁻¹) | (%) |
| Example 1 | 2254 | 1961 | 87.0 |
| Comparative | 3032 | 2156 | 71.1 |
| Example 1 | | | |
| Comparative | 2590 | 1206 | 46.5 |
| Example 2 | | | |
| Comparative | 1249 | 1003 | 80.3 |
| Example 3 | | | |
| Comparative | 1834 | 1558 | 84.9 |
| Example 4 | | | |

As can be seen from FIGS. 5A and 5B and FIGS. 6A and 6B and Table 4, Example 1 showed superior initial efficiency and cycle life characteristics compared to Comparative Examples 1 to 4.

Accordingly, it was confirmed that the negative electrode active material for a lithium secondary battery according to the present disclosure may simultaneously address the low initial efficiency and poor cycle life characteristics that occur when using silicon-based materials, thereby implementing high energy density lithium storage materials.

The features, structures, effects, and the like described in the exemplary embodiments above are included in at least one embodiment of the present disclosure and are not necessarily limited to a single embodiment. Furthermore, the features, structures, effects, and the like exemplified in each exemplary embodiment can be combined or modified in other embodiments by those skilled in the art to which the embodiments pertain. Therefore, such combinations and modifications should be construed as being within the scope of the present disclosure.

What is claimed is:

1. A negative electrode active material for a lithium secondary battery, the negative electrode active material comprising:
a magnesium silicate comprising Mg₂SiO₄ and/or MgSiO₃; and
crystalline silicon.

2. The negative electrode active material for a lithium secondary battery according to claim 1, further comprising magnesium oxide (MgO).

3. The negative electrode active material for a lithium secondary battery according to claim 1, comprising about 1 to 150 parts by weight of the magnesium silicate based on 100 parts by weight of the crystalline silicon.

4. The negative electrode active material for a lithium secondary battery according to claim 2, comprising about 0.5 to 5 parts by weight of the magnesium oxide based on 100 parts by weight of the crystalline silicon.

5. The negative electrode active material for a lithium secondary battery according to claim 1, wherein the crystalline silicon is polycrystalline silicon, and the polycrystalline silicon comprises a first crystalline silicon including a (111) plane, a second crystalline silicon including a (220) plane, and a third crystalline silicon including a (311) plane.

6. The negative electrode active material for a lithium secondary battery according to claim 5, wherein a ratio of grain sizes of the first crystalline silicon, the second crystalline silicon, and the third crystalline silicon is 1:(0.5 to 1):(0.5 to 1).

7. A method for preparing a negative electrode active material for a lithium secondary battery, the method comprising:
preparing a mixed powder by mixing silicon (Si), silicon monoxide (SiO), and magnesium hydride (MgH₂); and
heat-treating the mixed powder to obtain a heat-treated product.

8. The method according to claim 7, wherein the mixed powder comprises the silicon, the silicon monoxide (SiO), and the magnesium hydride at a weight ratio of 1:(1 to 2):(0.1 to 1).

9. The method according to claim 7, wherein the heat treatment is performed at about 700° C. to 1000° C.

10. The method according to claim 7, further comprising:
pulverizing the heat-treated product to obtain a pulverized heat-treated product; and
carbon coating the pulverized heat-treated product.

11. The method according to claim 10, wherein the pulverizing is performed by a ball mill method.

12. The method according to claim 11, wherein the ball mill method is performed with a ball-to-powder weight ratio (BPR) of about 5:1 to 50:1 for 10 to 36 hours.

13. The method according to claim 10, wherein the carbon coating is performed under an argon (Ar) gas atmosphere at about 350° C. to 1200° C. for 0.5 to 10 hours.

14. A negative electrode for a lithium secondary battery, the negative electrode comprising the negative electrode active material for a lithium secondary battery according to claim 1.

15. A lithium secondary battery comprising:
the negative electrode according to claim 14;
a positive electrode;
a separator positioned between the negative electrode and the positive electrode; and
an electrolyte.

16. A negative electrode active material for a lithium secondary battery, wherein the negative electrode active material is obtained by:
preparing a mixture of silicon, silicon monoxide, and magnesium hydride;
heat-treating the mixture at a temperature of about 700° C. to 1000° C. to form a magnesium silicate phase comprising Mg₂SiO₄ and/or MgSiO₃; and
optionally pulverizing and carbon-coating the heat-treated product,
wherein the negative electrode active material comprises:
the magnesium silicate phase, and
crystalline silicon.

17. The negative electrode active material according to claim 16, wherein about 1 to 150 parts by weight of the magnesium silicate phase is present based on 100 parts by weight of the crystalline silicon.

18. The negative electrode active material according to claim 16, further comprising magnesium oxide in an amount of about 0.5 to 5 part by weight, based on 100 parts by weight of the crystalline silicon.

19. The negative electrode active material according to claim 16, wherein the crystalline silicon is polycrystalline silicon comprising a first crystalline silicon including a (111) plane, a second crystalline silicon including a (220) plane, and a third crystalline silicon including a (311) plane.

20. The negative electrode active material according to claim 19, wherein a ratio of average grain sizes of the first crystalline silicon, the second crystalline silicon, and the third crystalline silicon is 1:(0.5 to 1):(0.5 to 1).
